(19) United States
(12) Patent Application Publication
(10) Pub. No.: US 2013/0330062 A1
(43) Pub. Date: Dec. 12, 2013

(54) AUTOMATIC CREATION OF MOVIE WITH IMAGES SYNCHRONIZED TO MUSIC

(71) Applicant: MYMUSAIC INC., Rye, NY (US)

(72) Inventors: Alexander John Meikle, Rye, NY (US); Thompson Huang, LiaoNing (CN)

(21) Appl. No.: 13/912,140

(22) Filed: Jun. 6, 2013

Related U.S. Application Data
(60) Provisional application No. 61/657,140, filed on Jun. 8, 2012.

(51) Int. Cl. H04N 9/87

(52) U.S. Cl. CPC H04N 9/87
USPC 386/285

(57) ABSTRACT

A movie is automatically created from a music track and a series of images such that placement of the images is synchronized to the music. The minimum image display time is automatically determined by the pace of the music. The pace can be determined by the beats per minute for the music. Two procedures are used for identifying beats, corresponding to hard and soft beats. The best transition points for the images in the movie are automatically determined. When the music has a relatively long quiet portion, the number of images during the quiet portion is adjusted so that each image does not exceed the maximum duration, and the duration of images during the quiet portion is approximately equal.

### CROSS-REFERENCE TO RELATED APPLICATIONS

This application claims priority to U.S. provisional patent application Ser. No. 61/657,140, filed Jun. 8, 2012, having a common inventor herewith, the disclosure of which is hereby incorporated by reference herein.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

The present invention relates to automatic movie generation, and more particularly, is directed to automatically creating a movie from a music file and a series of images such that placement of the images is synchronized to the music.

Combining an audio signal with a file of still images to make a movie is well-known. A large part of movie editing is directed to properly aligning the images and sounds. When a file of still images is involved, matching the images with the beats of the music is the most tedious and time-consuming part of editing, because there are so many edits that need to be made, particularly when using many images.

Properly associating the images with the music is critical to creating an engaging viewing experience. Further, morei mages can be shown in less time without seeming chaotic to the viewer. This faster pace creates a narrative that drives the story and keeps focus on the content, not the effects, much like a motion picture. Humans can perceive images very rapidly; the likeness of the nearby content affects human perception speed. For example, film has a rate of 24 frames per second, 0.041 seconds per image, which is comfortable as the nearby content is similar. Though individual photographs would not be shown as quickly, the absence of effects provides significant room to increase the speed, which depends on the importance and likeness of the content.

Microsoft Windows XP MovieMaker has a storyboard view and a timeline view. In the storyboard view, a user drags and drops thumbnail images into a matrix, and imports an audio file. The user specifies a default picture duration and a transition duration. Then, in the timeline view, the user drags and drops transitions between the pictures, such as fade-in or fade-out from/to white/black, and optionally adjust the start and end times for a picture by dragging and dropping its boundaries. This is tedious for a user to use.

Microsoft MovieMaker includes an “AutoMovie Wizard” that evaluates the pictures and audio, then creates a movie. However, audio is sometimes undesirably clipped, and/or some pictures may be omitted.

U.S. Pat. No. 7,945,142 (Finkelstein), assigned to Microsoft Corporation, describes an audio/visual editing program having a selection element that can automatically adjust the viewing time of a digital image to begin and end during the visual data sequence between audio beats of an overlay audio data sequence.

Apple QuickTime Pro enables a user to set a picture duration and combine a series of still images to create a movie that plays like a slideshow, then add an audio track which is sped up or slowed to fit in the paste destination. The paste destination may be the duration of some or all of the images. Alternatively, the audio track can determine the movie duration, and image duration will alter accordingly. A screen-based graphical user interface, in timeline view, shows “tracks” of audio, video or data (ex: captions) that comprise a movie, and enables the start and end times of each track to be adjusted by dragging and dropping its boundaries.

Google Picasa 3 enables importing pictures and an audio file, selecting transitions such as pan and zoom, and then automatically creates a movie file in .wmv or .mov format. Options for lining up photos with music are: truncate audio (cut off music at end of movie), fit photos into audio with the same duration for each photo, or loop the photo sequence to match the length of the audio, with each photo displayed for the same “slide duration” set by the user.

U.S. Patent Application Publication 2008/0055469 (Miyasaka) discloses producing a music-and-image synchronized motion picture. Characteristics are extracted from the music, including beats, accents and points of tempo change, and then the music is divided into segments based on tempo changes, beats or melodic phrases. The images are analyzed and associated with the audio to create a movie in which images are naturally switched at separation positions of the music, or in which the images are sequentially displayed synchronously with the beats.

U.S. Pat. No. 7,534,951 (Yamashita) extracts the beat of a music piece and displays an animate image, such as a doll or robot, that moves (dances) synchronously with the beat of the music. Yamashita teaches that instead of an animation, still images can be displayed in synchronization with the music.

A beat is a big variation of sound energy. An excellent explanation of automated beat detection, in the time domain and in the frequency domain, is provided by Frederic Patin at www.gamedev.net/pages/resources/_/technical/math-and-physics/beat-detection-algorithms-r1952.

First, the time domain is discussed. Let a(n) be sound amplitude values for a left channel, and b(n) be sound amplitude values for a right channel, taking 1024 samples every 0.05 seconds. The instant energy e is:

$$e = ( {e}_{right} + {e}_{left} ) = {\sum }_{k = {i}_{0}}^{{i}_{0} + 1024} {a ( k )}^{2} + {b ( k )}^{2} \qquad ( Eq . 1 )$$

Assuming a human ear energy persistence model in which the human hearing system remembers only about 1 second, or 43*1024=44032 samples, and that the samples are stored in a history buffer B[n][i], where n=0 for left channel, and n=1 for right channel, and i=0 . . . 44032, the local average energy <E> is:

$$〈 E 〉 = \frac{1024}{44032} * {\sum }_{i = 0}^{440.32} {( B [ 0 ] [ i ] )}^{2} + {( B [ 1 ] [ i ] )}^{2} \qquad ( Eq . 2 )$$

A beat occurs when e>(C*<E>), where C is a time-domain constant that determines the sensitivity to beats. For techno and rap music, C=1.4 is a good choice. For rock music, which is noisier, C=1.0 is a good choice.

The problem with the time domain analysis is that it is blind to frequency sub-bands, meaning that a beat that is human-perceptible escapes being classified as a beat. In particular, human perception is most sensitive to low pitched noises.

Accordingly, the frequency domain is discussed, since it is easy to analyze frequency sub-bands in this domain.

Each set of 1024 time domain samples is analyzed using a Fast Fourier Transformation (FFT) to provide a spectrum of 1024 frequencies, expressed as complex number aₙ+i*bₙ, n=0 . . . 1023. These are divided into sub-bands, here, 32 sub-bands, and the sound energy in each sub-band is compared to the recent average energy for the sub-band to detect a beat, and thereby, for instance, control an animation.

Let the buffer B[k], k=0 . . . 1023, contain the 1024 frequency amplitudes. The energy in each sub-band Eₛ(i), i=1 . . . 32, is:

$${E}_{s} [ i ] = \frac{32}{1024} * {\sum }_{k = i * 32}^{( i + 1 ) 832} B [ k ] \qquad ( Eq . 3 )$$

The energy history buffer for the sub-band contains the last 43 computations for the sub-band. It will be recalled that there are 43 sets of 1024 samples in about one second. The average energy for the i-th sub-band <E₁> is:

$$〈 {E}_{i} 〉 = \frac{1}{43} * {\sum }_{k = 0}^{42} {E}_{i} [ k ] \qquad ( Eq . 4 )$$

Then, if Eₛ(i)>(C*<Eᵢ>), there is a beat in the i-th frequency sub-band, where C is a frequency-domain constant that determines the sensitivity to beats. Usually, C=250 is a good choice.

There is room for improvement in creating a movie in which images are automatically synchronized with music in a manner that is easy to use and not tedious.

### SUMMARY OF THE INVENTION

In accordance with an aspect of this invention, there is provided a method of automatically synchronizing an image file to a music file to create a movie file. The image file and the music file are received. A minimum image display time is automatically determined based on the pace of the music. Transition points for the music file are automatically determined so that images will be displayed for at least the minimum image display time when the movie file is played. The images from the image file are automatically associated with the transition points to create the movie file.

In accordance with another aspect of this invention, there is provided a method of automatically synchronizing an image file to a music file to create a movie file. The image file and the music file are received. A minimum image display time is automatically determined. Transition points for the music file are automatically determined so that images will be displayed for at least the minimum image display time when the movie file is played. The transition points correspond to the strongest beats in the music. The images from the image file are automatically associated with the transition points to create the movie file.

In accordance with a further aspect of this invention, there is provided a method of automatically synchronizing an image file to a music file to create a movie file. The image file and the music file are received. A minimum image display time is automatically determined. Transition points for the music file are automatically determined so that images will be displayed for at least the minimum image display time when the movie file is played. The transition points occur during the louder portions of the music. The images from the image file are automatically associated with the transition points to create the movie file.

It is not intended that the invention be summarized here in its entirety. Rather, further features, aspects and advantages of the invention are set forth in or are apparent from the following description and drawings.

### BRIEF DESCRIPTION OF THE DRAWINGS

FIGS. 1A and 1B are charts of waveforms illustrating beats;

FIG. 2 is a block diagram illustrating a configuration in which the present invention is applied;

FIG. 3 is a block diagram illustrating another configuration in which the present invention is applied;

FIGS. 4-6 are a flowchart illustrating how user 101 uses server 102 to make a movie;

FIG. 7 is a chart illustrating a music waveform referred to in discussing transition point determination;

FIGS. 8A-8B are charts referred to in explaining image placement for the waveform of FIG. 7;

FIGS. 9A-9C are charts referred to in explaining image placement during a long quiet portion of music;

FIG. 10 is a flowchart illustrating another embodiment of automatic movie creation; and

FIGS. 11A-11E are charts referred to in explaining image placement in the embodiment of FIG. 10.

### DETAILED DESCRIPTION

The present invention is a software program that accepts a file of images and a music file, and automatically synchronizes the images to the music. Advantageously, a user can select images and arrange the images, and then easily determine which of several songs results in the best movie for the image, without the need to engage in additional selection, arranging or editing. In contrast, with conventional editing software, it is too laborious to manually synchronize the same image file to several different songs, to understand which song fits best.

As used herein and in the claims, “editing” refers to associating an image with a portion of a music file. In the present invention, editing is completely automated. Users are never required to make cuts or trim content to match a beat.

As used herein and in the claims, “image” means either a still image or a short video clip.

Songs usually have one most apparent beat rhythm. Prior art automatic synchronization software usually finds the beats for the most apparent beat rhythm, and synchronizes the images to these beats. However, this is sub-optimal because other beat rhythms must be identified to facilitate a faster pace that moves with other eats in between the most apparent beats. For instance, common drum beats usually include snare and bass, and prior art automated movie creation software synchronizes to only one of the snare and bass beats.

Contemporary music is not limited to standard 4/4 time, and can also be in 3/4, 7/8, 11/16 or even a combination. The beats change during such music.

The present invention is able to synchronize to multiple beat rhythms, providing a faster pace of images, and consequent improved story-telling ability for the movie. Moreover, the images have a better perceived quality of synchronization when sometimes the non-primary beat rhythm is used for synchronization.

As described herein, automatic synchronization is performed according to a procedure that (i) establishes a minimum image display time based on the pace of the music, (ii) automatically finds the best transition points, (iii) simultaneously uses two processes to find transition points, (iv) uses a limited “detection range” to identify the most appropriate beat within that section of the music near the image, and (v) when the short segment is quiet, automatically moves to a next short segment. This automatic synchronization is more sophisticated than in conventional automatic synchronization programs, and so produces a much more perceptually engaging movie that is far easier to create.

The beat detection procedure evaluates short (0.3-1.0 second) segments that follow each image, and simultaneously uses two beat detection processes, to find beats in each segment.

FIG. 1A shows a hard beat, while FIG. 1B shows a soft beat. A hard beat includes a short high energy burst, while a soft beat has energy more evenly distributed over a longer time range.

Then, the images are automatically associated with the music such that transitions occur at the beats, with the minimum image display time, usually 0.4-2.0 seconds, being responsive to the pace of the music. The pace of the music is indicated by either the beats per minute (BPM), the number of energy peaks, or other suitable metric, or manually through a universal pace control.

The beats reflected in the BPM count are not always audible. So, these beats are not always human-identifiable transition points, not are they universally accurate measurements of how fast a song sounds or feels. More specifically, simply using actual beats as transition points is undesirable as the music may be too fast or too slow. When the music is too fast, such as more than 160 BPM, the time per image is reduced to under 60/160 seconds (0.0375 seconds), which may be an uncomfortably fast-paced image display. On the other hand, when the music is very slow, the time per image may be too long to keep the user's attention engaged. Instead, it is better to transition on energy changes subject to a minimum and maximum image duration, to keep the pace comfortable: not too fast, not too slow. In other words, a required minimum image duration creates a more consistent pace, and the variability of the image duration improves the engaging-ness of the movie.

Hard beats, such as snare drum beats, are typically more frequent than soft beats, such as bass beats. For fast music, the hard beats are automatically selected as transition points, while for slow music, the soft beats are automatically selected as transition points. Songs may contain fast and slow portions, so the resulting movie appears extremely well-matched to the song due to the image association occurring via different techniques during the different portions of the song.

A “quietness threshold” is determined for each audio file. When a segment lacks beats that exceed the quietness threshold, the image continues to be displayed during the segment, and the next segment is evaluated, until there is a beat that exceeds the quietness threshold. For instance, a song may start with a particular melody, then become quiet, and then a chorus occurs. The present synchronization procedure holds an image during the quiet section, and transitions when the chorus starts.

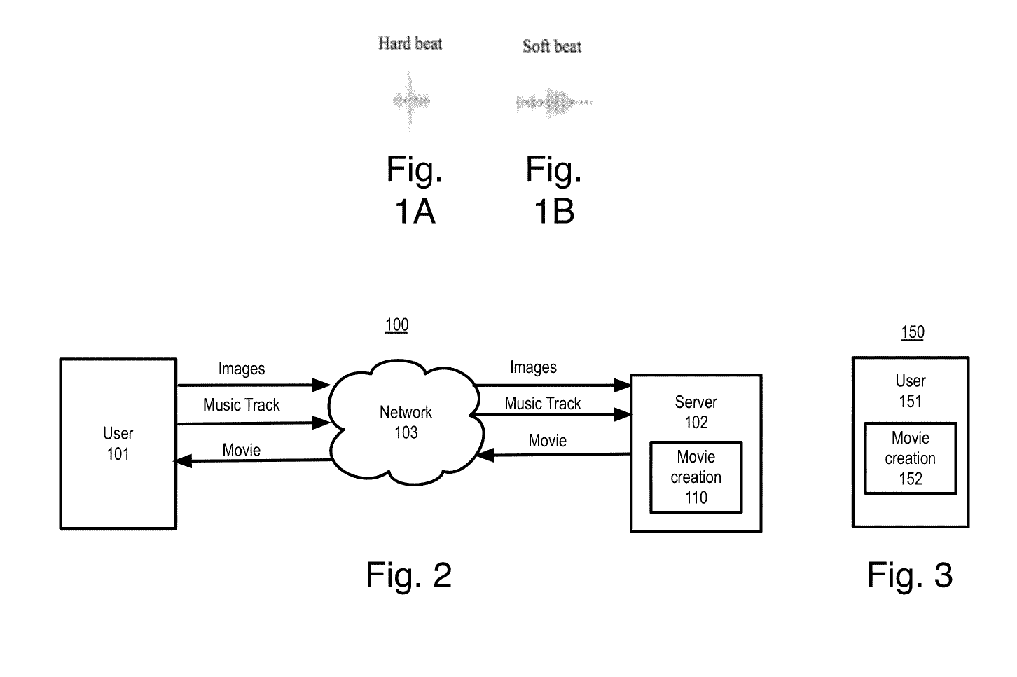

FIG. 2 is a block diagram of system 100 including user 101, server 102 and network 103. User 101 is a personal computer, a smart phone, a tablet computer or other suitable computing device having suitable software for communicating via network 103, such as browser software. Server 102 is a general-purpose computer or computers programmed to receive and send information via network 103, and to execute movie creation program 110, discussed below. Network 103 is a communication network such as the Internet.

User 101 and server 102 are coupled to network 103 using suitable wireline or wireless communication channels.

Briefly, user 101 uploads a music track and images to server 102, along with descriptive data and an optional mode selection. Server 102 then creates and stores a movie file in which the images are synchronized to the beats of the music, and sends a link to the movie file to user 101. User 101 then actuates the link to view the movie, such as by downloading the movie file or streaming the movie file from server 102 to user 101. User 101 can send the link to others, so that they, too, can view the movie.

In some embodiments, instead of uploading data via network 103, user 101 provides a removable storage medium, such as magnetic disk, optical disk, USB memory stick and so on, to server 102.

FIG. 3 is a block diagram illustrating another configuration in which the present invention is applied. Here, movie creation program 152 executes on user device 151 to create a movie file stored on user device 151. Movie creation program 152 is similar to movie creation program 110, and for brevity, will not be discussed further.

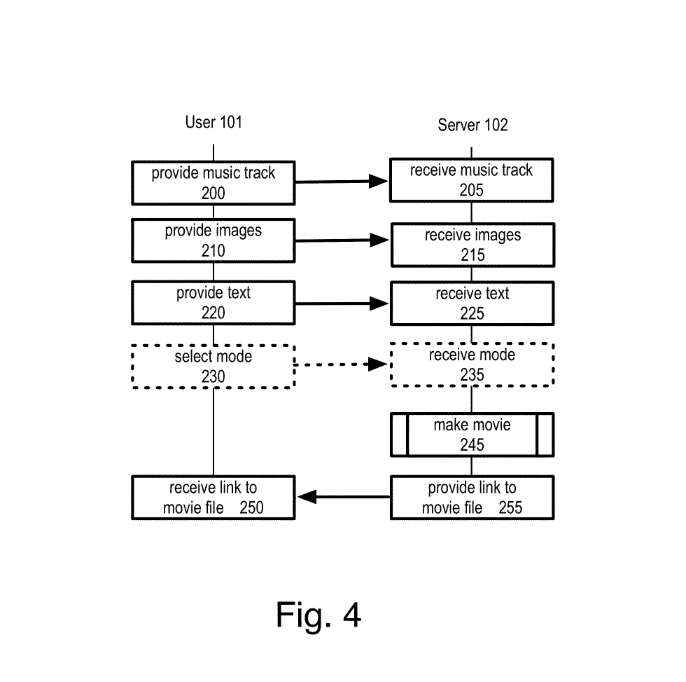

FIG. 4 is a flowchart illustrating how user 101 uses server 102 to make a movie.

At step 200, user 101 uploads a music track to server 102. The music track is a digital file in a suitable format such as .mp3, .m4a, or .way. Usually, the music track has a left channel and a right channel.

At step 205, server 102 receives the uploaded music track, and determines the maximum number of allowable images based on the time duration of the music track, T in seconds. At this point, for sizing purposes only, each image is assumed to have a duration of 2 seconds, and the transition time between images is assumed to be 2 seconds. Accordingly, the maximum number of images is T*(2+2). In other embodiments, other image durations and transition times are used. In other embodiments, the maximum number of images is fixed at a particular value, such as 100 images, regardless of the duration of the music track.

At step 210, user 101 uploads images to server 102. As used herein and in the claims, an “image” means a photographic image, a graphic image, or a video file. Each image is represented by a digital file in a suitable format such as .bmp, .tiff, .jpg, .mp4, .avi, .flv, .mpeg, .m4v, .pcx, .png, .ppm, and so on. At least one image file must be uploaded. If the image file includes audio information, the audio information is deleted or ignored by server 102. Let the total number of uploaded images be N_IMAGES.

The image files can be uploaded using a directory-type interface, that is, a drop-down menu where the user selects files from a directory, a bulk uploading procedure such as file transfer protocol (FTP), a graphical user interface (GUI), or other suitable technique. The GUI may be arranged as a matrix of thumbnail images, with video files being specially indicated; the GUI makes it easy for the user to re-arrange the order of the images.

At step 215, server 205 receives the uploaded image files, and ensures that the number of images does not exceed the maximum number of images determined at step 205. If an image is a video file, its actual duration is used in the determination of the maximum number of images that can be synchronized with the music track. If there are too many images, server 205 requires user 101 to delete images until all images can be accommodated.

At step 220, user 101 provides text to include in the movie, including metadata such as a title, creator name, creation date, description, theme keywords, identification of who is in the movie, and so on. In some embodiments, user 101 is able to provide a caption or watermark that is superimposed at the same place in each image.

At step 225, server 102 receives the text for the movie from user 101.

At optional step 230, indicated by dotted lines in FIG. 3, user 101 provides mode selection information to control how the set of images are synchronized to the music. In one embodiment, the modes are chosen from: (mode 1) truncate audio if the images can be displayed in less than the entire audio signal; (mode 2) repeat the image sequence, if the images can be displayed in less than the entire audio signal; (mode 3) distribute the images across the audio signal, generally evenly; (mode 4) distribute the images so that the slow parts of the music have extended image display. Other modes are available in other embodiments.

The user may also specify a minimum image duration and/or a maximum image duration, in seconds. The user may select which type of transition is used between images, such as none, dissolve, pan-zoom-in, pan-zoom-out, fade-in or fade-out.

The user may specify the output format of the movie file.

At step 235, server 102 receives the mode information for the movie from user 101.

At step 245, server 102 creates the movie file corresponding to the information provided from user 101, with the images synchronized to the music track, discussed in detail below. Server 102 stores the movie file and creates an address link for the movie file. The movie file is created in a suitable format such as .wmv or .mov format.

At step 255, server 102 provides the address link for the movie file to user 101.

At step 250, user 101 receives the address link for the movie file. User 101 can then download the movie file from server 102 to user 101, or can instruct server 102 to play the movie such as via streaming video via network 103.

Thus, user 101 is able to easily create a movie file, without the tedium of manually determining the start and end points for each image and each transition.

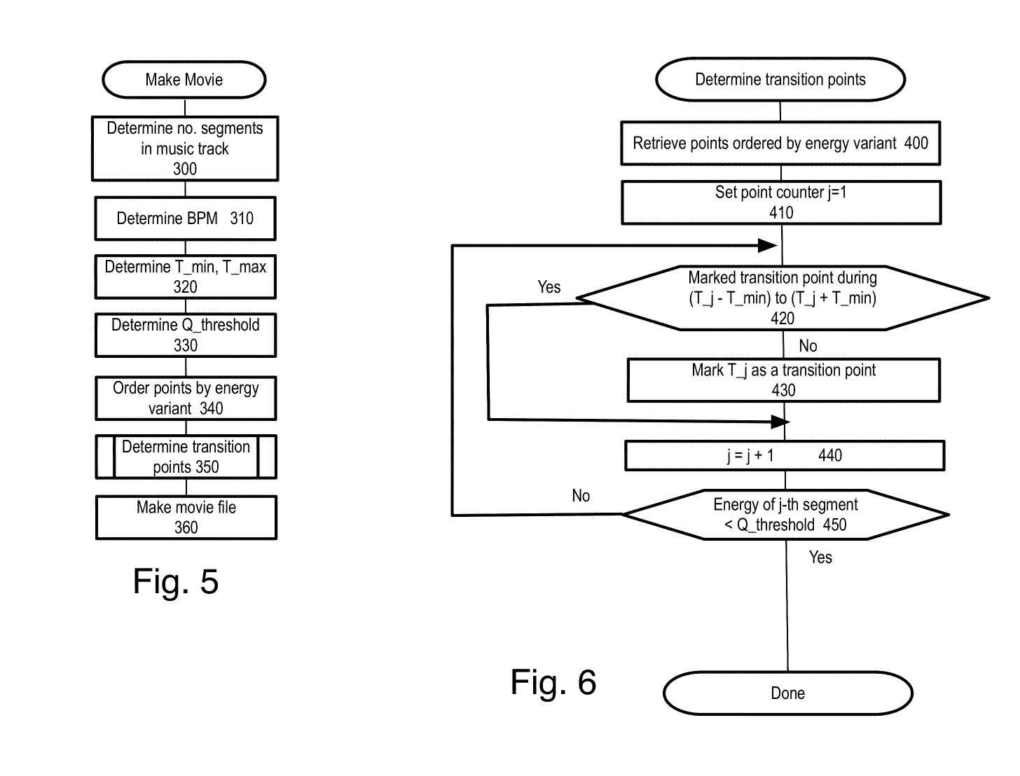

User 101 is able to import the created movie file into conventional movie editing software, such as Microsoft MovieMaker or Apple QuickTime Pro, and manually adjust the start and end points for each image and each transition, according to the capabilities of the conventional movie editing software. FIG. 5 is a flowchart illustrating how server 102 makes a movie file.

At step 300, server 102 determines the number of segments m, in the music track. In one embodiment, each segment has 1024 samples corresponding to 0.01 seconds of music. A sample in a segment is indicated as S(n)=A(n)+B(n), n=0 . . . 1023, where A(n) is a left channel and B(n) is a right channel. It will be recalled that the duration of the music track, in seconds, is T. The number of segments m is given by m=T/0.01. For example, a 2 minute music track has duration T=120 seconds, and m=120/0.01=1200 segments.

At step 305, server 102 determines the beats per minute (BPM) for the entire music track as follows. The BPM affects the duration of images, and transition times, in the movie. A higher BPM corresponds to faster music and results in shorter image durations, while a lower BPM corresponds to slower music and results in longer image durations.

To find beats, it is easiest to examine the low frequency energy in a signal. In particular, drum beats have high amplitude in low frequencies. So, the music signal is converted from the time domain to the frequency domain. For each segment, server 102 computes the fast Fourier transformation (FFT) for the segment, to determine the amplitude F(n), n=0 . . . 1023, of each of the 1024 frequencies in the segment. Let x(n) be the music signal in the time domain, N be the number of samples in the segment (N=1024), t_i be the time in seconds, F_s be the sampling frequency, X(f, t_i) be the short-time Fourier transformation at the frequency f and the segment i, then

$$X ( f , {t}_{i} ) = {\sum }_{n = 0}^{N - 1} x ( n + {F}_{s} {t}_{i} ) * {e}^{- \frac{2 iπ fn}{N}} , \\ f = 0 , 1 , … , N - 1 \qquad ( Eq . 5 )$$

As mentioned, a suitable value for the segment size is 10 ms (0.01 seconds). The interval between two successive FFT analyses t_(i+1) to t_(i), also referred to as the hop size, can be set to 10 msec, as no overlap between analysis windows is needed.

In the following steps, only the magnitude of the FFT is used.

Let f_min and f_max control the frequency range of interest, such as f_min=100 Hz and f_max=10 kHz. Let E(i) be the energy for the selected frequency range, while E_t(i) is the energy for the total frequency range.

$$\begin{matrix}E ( i ) = {\sum }_{f = f\_min}^{f\_max} \vert X ( f , {t}_{i} ) \vert & ( Eq . 6 ) \\ {E}_{t} ( i ) = {\sum }_{f = 0}^{N - 1} \vert X ( f , {t}_{i} \vert & ( Eq . 7 )\end{matrix}$$

A beat is defined as occurring when either of the following are true, with k_{—}1 and k_{—}2 being constants:

E(i)>k₁*Eₜ(i), where 0<k₁<0.8 (Eq. 8)

E(i)>k₂*E(i−1), where 2<k₂<3 (Eq. 9)

Equation 8 checks for a hard beat. Equation 9 checks for a soft beat. When a beat occurs in the i-th segment, using either of the definitions, the beat count for the i-th segment, Bc(i)=1. Otherwise, Bc(i)=0. Let the duration of the music file in minutes be t. It will be recalled that the number of segments in the music file is m. The beats per minute (BPM) for the music file is given by:

$$B P M = \frac{1}{t} {\sum }_{i = 0}^{m} Bc ( i ) \qquad ( Eq . 10 )$$

At step 320, movie creation program 110 determines the minimum image duration for a still image, such as a photograph or graphic image. The minimum image duration, in seconds, is T_min=k_{—}3/BPM, where k_{—}3 is a constant such as 2500. The maximum image duration, in seconds, can be set at any convenient value, such as T_max=10*T_min.

In some embodiments, the maximum and/or minimum image durations depend on the number of images in the image file, to promote more uniform distribution of the images along the music.

At step 330, movie creation program 110 determines the quietness threshold, Q_threshold, where transitions are not to occur, ensuring that transitions occur during the louder portion of the music. Recalling that m is the number of segments in the music,

$$\begin{matrix}{Q}_{threshold} = {k}_{3} * {E}_{avg} , \\ 0.5 < {k}_{3} < 0.8 & ( Eq . 11 ) \\ {E}_{avg} = \frac{1}{m} {\sum }_{i = 1}^{m} E ( i ) & ( Eq . 12 )\end{matrix}$$

In some embodiments, E_avg is evaluated for a portion of the music, such as 30 seconds or 3000 segments, instead of for the entire music track.

At step 340, movie creation program 110 orders the segments by the amount of energy change relative to the previous segment, to ensure that transitions occur in the high-energy segments and not the low-energy segments. This approach to selecting transition points is referred to as “strongest beats first”.

The difference in energy between the i-th segment and the next segment is defined as D_i=E(i+1)−E(i), for i=0 . . . n−1, and n being the number of FFT samples in a segment (such as 1024).

Movie creation program 110 selects M=Max (D_i) for a list i=0 . . . n−1, and places this D_i as the first value in a buffer.

The neighboring difference values for a duration T_min immediately temporally preceding and immediately temporally succeeding the i-th value are removed from the list. The i-th difference value is also removed from the list. This removal ensures that images will be displayed for at least the minimum display time T-min.

In another embodiment, the neighboring difference values are not removed at this time.

The next largest value remaining on the list is selected, and so on, until the largest of the D_i values have been sorted by amplitude into the buffer.

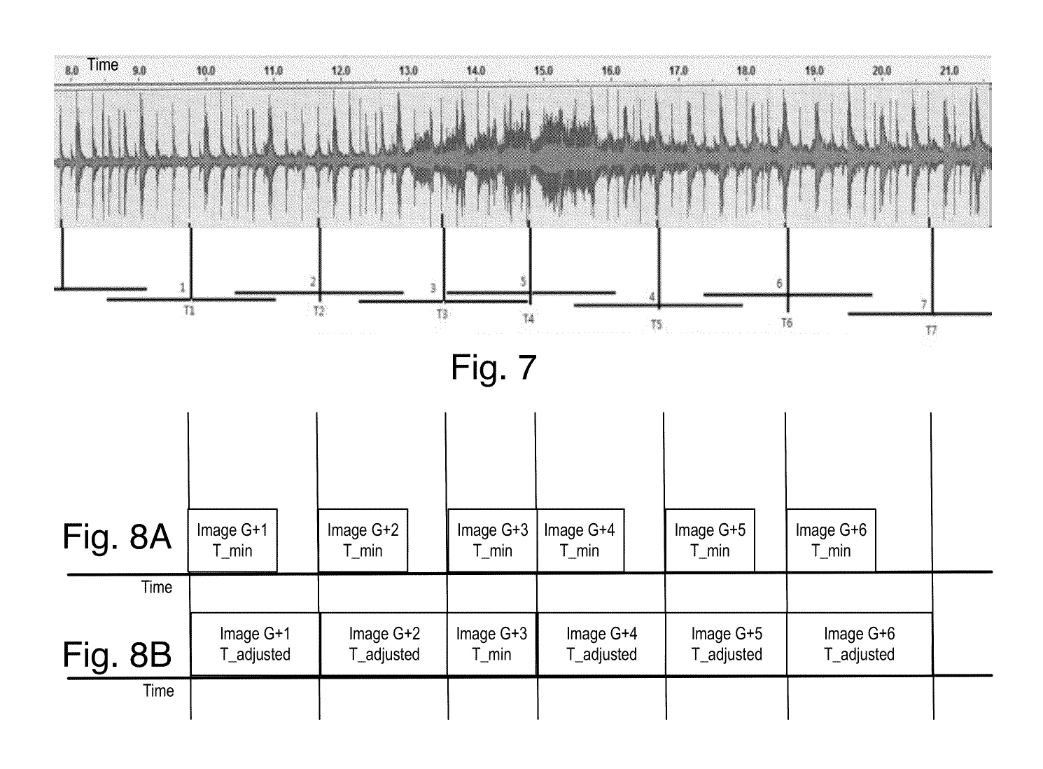

For instance, FIG. 7 shows a music waveform from 8 seconds to 21 seconds. The seven largest difference values are indicated by vertical lines with numbers at their base. Each difference value has at least T_min between the preceding difference value and the succeeding difference value. These difference values are located at the following times, in seconds: 9.7, 11.6. 13.5, 14.8, 16.7, 18.6, 20.7. The ordering by amplitude is D_{—}9.7, D_{—}11.6. D_{—}13.5, D_{—}16.7, D_{—}14.8, D_{—}18.6, D_{—}20.7, that is, the fifth value in the time sequence is larger than the fourth value, otherwise, earlier time sequences have larger amplitudes.

At step 350, movie creation program 110 determines the transition points. See discussion below with regard to FIG. 6.

At step 360, movie creation program 110 makes the movie file, by fitting the images between the transition points determined at step 350, adding the title, adding the creation date and creator name, and adding other text provided by the user as appropriate. Let it be assumed that the difference values indicated at 1-6 in FIG. 7 have been chosen as transition points.

As shown in FIG. 8A, six images G+1 . . . G+6 are respectively associated with the transition points, each having the minimum duration T_min.

As shown in FIG. 8B, the duration of each image is then adjusted by movie creation program 110 to extend until the next image. In this example, all images except for image G+3 have their durations extended, image G+3 is displayed for the minimum duration T_min.

Movie creation program 110 then checks whether the adjusted duration of any image exceeds the maximum duration. This will occur if the song has a long quiet portion. If so, movie creation program 110 adds the least number of additional images that will ensure all images have a duration not exceeding the maximum duration.

More specifically, movie creation program 110 determines the additional number of required images as the integer portion of the result of dividing the too-long-adjusted-image duration by the maximum image duration. Then, movie creation program 110 finds the best transition points, which are below the quietness threshold, so that the image durations in the quiet interval are approximately equal.

Then, the special effect for the transition is applied by movie creation program 110 at the start of each image duration; the special effect was chosen at step 230.

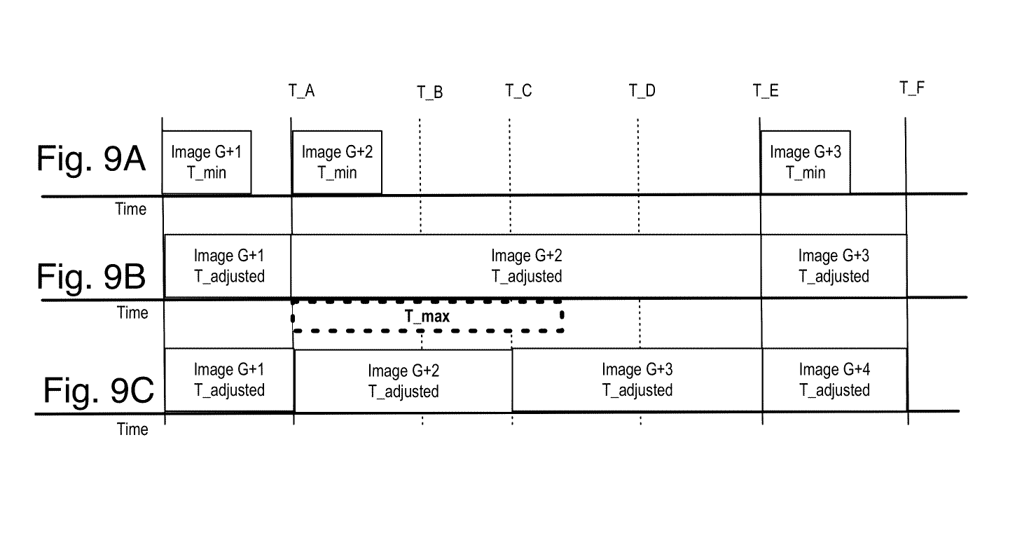

FIGS. 9A-9C show an example of automatically adjusting image duration when there is a long quiet portion in the music.

FIG. 9A shows that three images have been placed in a portion of the music, images G+1 to G+3. The vertical dotted lines indicate points that would be transitions, except that they occur during a quiet portion of the music, so they were not marked as transitions due to step 450.

FIG. 9B shows the image durations are adjusted to fit within the transition points. The duration of image G+2 exceeds the maximum image length T_max, shown as a dotted area. In this example, let the minimum image duration T_min=0.6 seconds, and the maximum image duration T_max=1.8 seconds. Let the adjusted duration of image G+2 be 3.1 seconds. Since INTEGER (3.1/1.8)=1, one additional image is needed. So, there will be a total of two images in the interval currently occupied by image G+2. There are three unused transition points in this interval, and selecting the middle one will result in the two images having approximately equal duration. Since this is a quiet portion, having the image durations approximately equal provides the most acceptable (soothing) result.

FIG. 9C shows the additional image in the quiet interval, and that the transition occurs at the middle of the otherwise unused transition points.

FIG. 6 shows determining the transition points.

At step 400, the ordered list is retrieved. In the example of FIG. 7, this is the list D_{—}9.7, D_{—}11.6. D_{—}13.5, D_{—}16.7, D_{—}14.8, D_{—}18.6, D_{—}20.7. The number of points in this list is six, no._points =6.

At step 410, the point counter j is set to 1.

At step 420, which is needed in the embodiment where neighboring difference values were not removed at step 340, movie creation program 110 checks if there is already a marked transition point in the time interval corresponding to the j-th point. If so, processing continues at step 440. If not, at step 430, image creation program marks T_j as a transition point.

At step 440, the point counter j is incremented.

At step 450, movie creation program 110 checks whether the energy of the (j+1)-th segment exceeds the quietness threshold. If not, that is, the quietness threshold has been reached, processing is complete.

Another embodiment of automatic movie creation will now be discussed.

This embodiment is referred to as “sequential time”. It is similar to the “strongest beats first” except as discussed below. The similar steps will not be discussed, for brevity.

It will be recalled that the “strongest beats first” embodiment identifies all of the beats in the music, then selects the strongest as transition points, subject to being at least T_min from a neighboring transition point.

In contrast, the “sequential time” embodiment places the first image, then finds the best transition point for the second image, places it, then finds the best transition point for the third image, and so on until the end of the music.

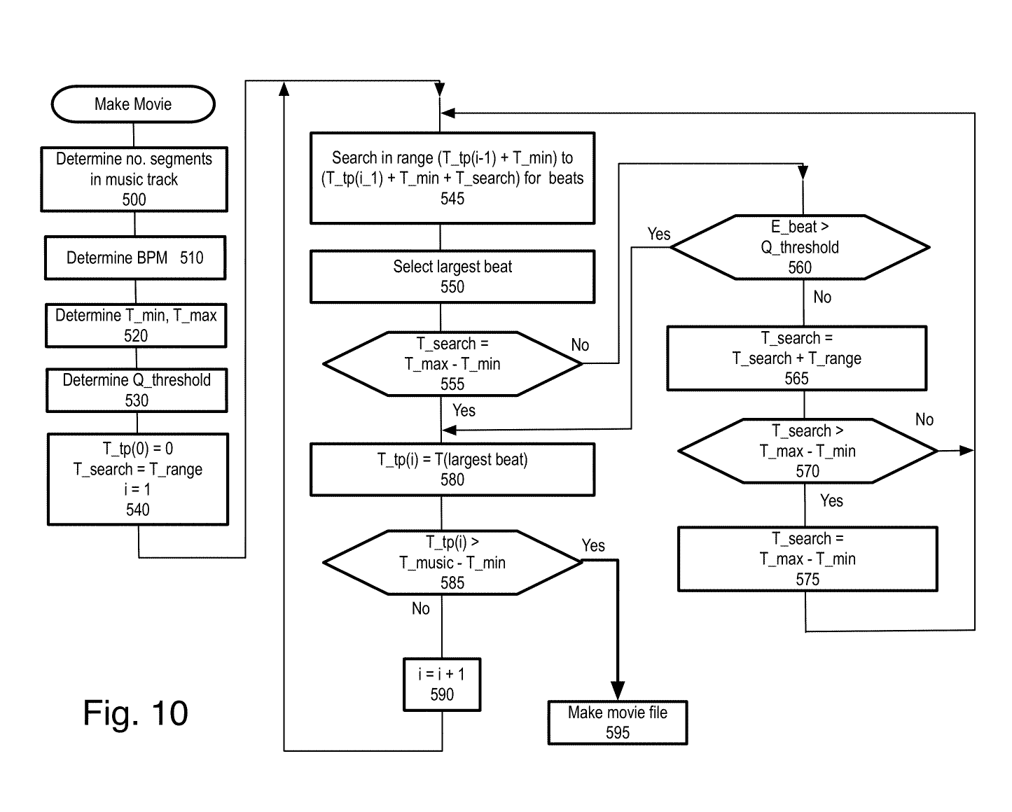

In this embodiment, movie creation proceeds as in FIG. 4, but at step 245, make movie, instead of going to FIG. 5, movie creation program 110 (or movie creation program 152) proceeds to FIG. 10.

Steps 500, 510, 520, 530 of FIG. 10 correspond to steps 300, 310, 320, 330 of FIG. 5.

At step 540 of FIG. 10, the first transition point is set to the start of the music, T_tp(0)=0. The search range is set to a predetermined range value, T_search=T_range. A counter i is set to 1.

At step 545, movie creation program 110 associates the start of image i with the (i−1)-th transition point, and sets the display duration of image i to end at T_tp(i−1)+T_min. Movie creation program 110 checks the range (T_tp(i−1)+T_min) to (T_tp(i−1)+T_min+T_search) for beats. A beat is identified as satisfying either of Equation 8 or Equation 9, above.

At step 550, movie creation program 110 selects the largest beat in the range.

At step 555, movie creation program checks whether the search range can be extended, that is, whether T_search=T_max−T_min, the difference between the maximum and minimum image display parameters. If the range can be extended, processing continues at step 560. If the range cannot be extended, processing continues at step 580.

At step 560, movie creation program checks whether the largest beat exceeds the quietness threshold. If not, the search range should be extended, if possible, to find a big enough beat, so processing continues at step 565. If the beat is large enough already, processing continues at step 580.

At step 565, movie creation program 110 extends the search range by T_range by setting T_search=T_search+T_range.

At step 570, movie creation program 110 checks whether the search range will extend beyond the maximum image display interval, that is whether T_search>T_max−T_min. If so, processing continues at step 575. If not, processing returns to step 545.

At step 575, movie creation program 110 adjusts T_search so that the search range will truncate at the maximum image display interval, T_search=T_max−T_min. Processing continues at step 545.

At step 580, the i-th transition point is set to the time of the largest beat just found, T_tp(i)=T(largest beat). The duration of the (i−1)-th image is adjusted to extend to the new i-th transition point.

At step 585, movie creation program 110 checks whether the end of the music has been reached, that is, whether at least T_min remains until the end of the music. If so, at step 590, movie creation program 110 increments i, and processing continues at step 545. If the end of the music has been reached, processing continues at step 595, which is similar to step 360 of FIG. 5.

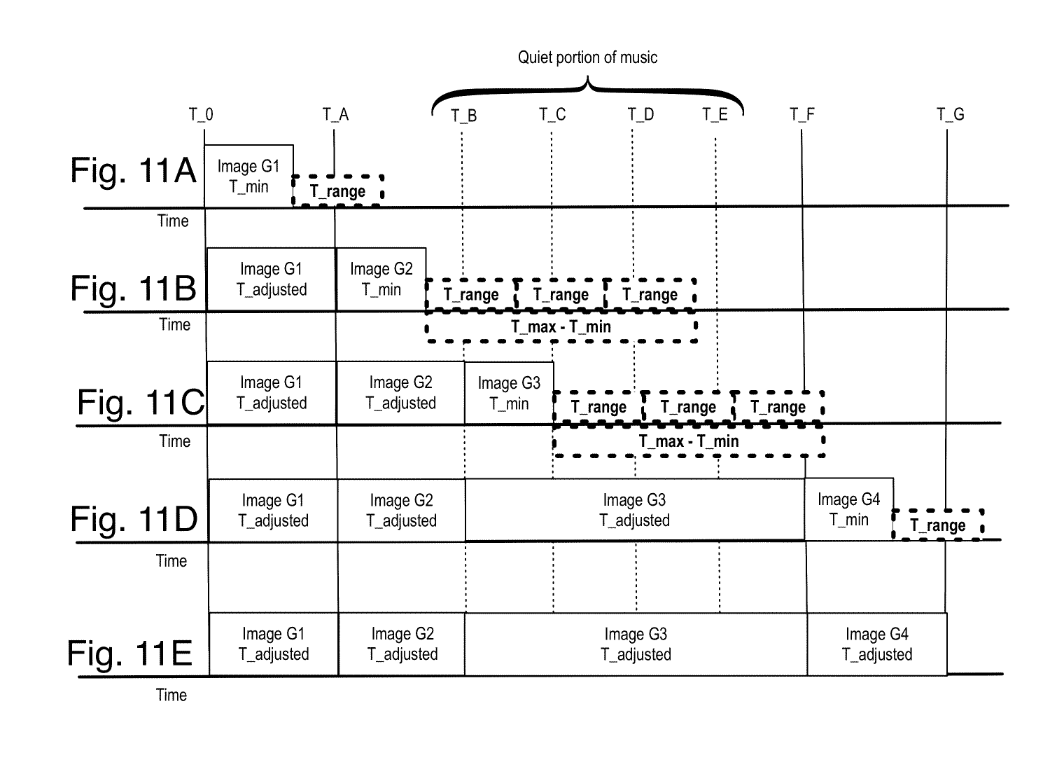

An example of operation of the “sequential time” embodiment will be discussed with regard to FIGS. 11A-11E.

As shown in FIG. 11A, at step 545, the start of displaying the first image G1 is associated with the start of the music T_{—}0, and the end of its display is at T_min. In this example, T_min=0.8 seconds. The search range is a duration of T_range after the end of the first image G1. In this example, T_range=1.0 seconds. At the first iteration of step 550, the largest beat in the search range is determined to occur at time T_A. Let it be assumed that the energy (signal amplitude) in this beat exceeds Q_threshold, so at the first iteration of step 580, this beat is selected as the next transition point, that is, T_tp(1)=T_A. The duration of image G1 is adjusted to extend from T_{—}0 to T_A. At step 590, image creation program 110 sets i=2, and processing returns to step 545.

As shown in FIG. 11B, at the second iteration of step 545, the start of displaying the second image G2 is associated with the most recent transition point T_A, and the end of its display is at T_A+T_min. The search range extends from the end of the second image G2 (T_A+T_min) until (T_A+T_min+T_range). At the second iteration of step 550, the largest beat in the search range is determined to occur at time T_B. However, let it be assumed that this is a quiet portion of the music, so the energy in the beat at T_B fails to exceed Q_threshold. At step 565, the search range is extended by T_range, so that the total search range is 2*T_range.

At the third iteration of step 550, the largest beat in the new part of the search range is determined to occur at time T_C. However, let it be assumed that the beat at T_C is weaker than the beat at T_B, so the energy in the beat at T_C fails to exceed Q_threshold. L At step 565, the search range is extended by T_range, so that the total search range is 3*T_range.

At the fourth iteration of step 550, the largest beat in the new part of the search range is determined to occur at time T_D. However, let it be assumed that the beat at T_D is weaker than the beat at T_B, so the energy in the beat at T_D fails to exceed Q_threshold. At step 565, the search range is extended by T_range, so that the total search range is 4*T_range. Let it be assumed that (3*T_range)=(T_max−T_min). Accordingly, at step 570, processing continues at step 575, trimming the search range back to (T_max−T_min). At the fifth iteration of step 550, there is no new part of the search range, so the beat at T_B remains the strongest. However, at step 555, the search range is at its maximum, so processing continues at step 580, and the second transition point is set to the time of the strongest beat in the search range, T_tp(2)=T_B. The duration of image G2 is adjusted to extend from T_A to T_B. At step 590, image creation program 110 sets i=3, and processing returns to step 545.

As shown in FIG. 11C, at the next iteration of step 545, the start of displaying the third image G3 is associated with the most recent transition point T_B, and the end of its display is at T_B+T_min. In similar manner, movie creation program 110 finds the strongest beat in the next search interval to be at T_D, but it is too quiet, so the search range is extended, and finds a stronger beat at T_E, but it is also too quiet, so the search range is extended a third time, and finds a strongest beat at T_F. The energy in the beat at T_F exceeds Q_threshold. The third transition point is set to the time of the strongest beat in the search range, T_tp(3)=T_F. The duration of image G3 is adjusted to extend from T_B to T_F. At step 590, image creation program 110 sets i=4, and processing returns to step 545.

As shown in FIG. 11D, at step 545, the start of displaying the fourth image G4 is associated with T_F, and the end of its display is at (T_F+T_min). The search range is a duration of T_range after the end of the fourth image G4. The largest beat in the search range is determined to occur at time T_G. Let it be assumed that the energy (signal amplitude) in this beat exceeds Q_threshold, so this beat is selected as the next transition point, that is, T_tp(4)=T_G. The duration of image G4 is adjusted to extend from T_F to T_G. At step 590, image creation program 110 sets i=5, and processing returns to step 545.

It will be observed that the “strongest beats first” technique ensures that the images during a quiet portion have approximately equal length (compare duration of images G+2 and G+3 in FIG. 9C), while the “sequential time” technique does not ensure approximately equal length during a quiet portion of the music (compare duration of images G2 and G3 in FIG. 11E).

Although illustrative embodiments of the present invention, and various modifications thereof, have been described in detail herein with reference to the accompanying drawings, it is to be understood that the invention is not limited to these precise embodiments and the described modifications, and that various changes and further modifications may be effected therein by one skilled in the art without departing from the scope or spirit of the invention as defined in the appended claims.

An appendix providing source code for a computer program embodying the present invention is provided.

What is claimed is:

1. A method of automatically synchronizing an image file to a music file to create a movie file, comprising:
receiving, at a computer, the image file and the music file,
automatically determining, by the computer, a minimum image display time based on the pace of the music,
automatically determining, by the computer, transition points for the music file so that images will be displayed for at least the minimum image display time when the movie file is played, and
automatically associating, by the computer, images from the image file with the transition points to create the movie file.

2. The method of claim 1, wherein the pace of the music is represented by the beats per minute of the music.

3. The method of claim 2, wherein the beats per minute is the beat count for the music divided by the duration of the music, and further comprising automatically determining, by the computer, that a beat exists in a segment of the music when the energy of a predetermined frequency band of the music in that segment exceeds either (i) a portion k_{—}1 of the total energy in the segment, or (ii) a portion k_{—}2 of the energy in the predetermined frequency band of a previous segment.

4. A method of automatically synchronizing an image file to a music file to create a movie file, comprising:
receiving, at a computer, the image file and the music file,
automatically determining, by the computer, a minimum image display time,
automatically determining, by the computer, transition points for the music file so that images will be displayed for at least the minimum image display time when the movie file is played, the transition points corresponding to the strongest beats in the music, and
automatically associating, by the computer, images from the image file with the transition points to create the movie file.

5. The method of claim 4, further comprising automatically determining, by the computer, that a beat exists in a segment of the music when either of two beat detection conditions exist.

6. The method of claim 5, wherein the first beat detection condition is that the energy of a predetermined frequency band of the music in the segment exceeds a portion k_{—}1 of the total energy in the segment, and the second beat detection condition is that the energy of the predetermined frequency band of the music in the segment exceeds a portion k_{—}2 of the energy in the predetermined frequency band of a previous segment.

7. The method of claim 4, wherein the minimum image display time is automatically determined based on the pace of the music

8. The method of claim 4, wherein the transition points occur during the louder portions of the music.

9. A method of automatically synchronizing an image file to a music file to create a movie file, comprising:
receiving, at a computer, the image file and the music file,
automatically determining, by the computer, a minimum image display time,
automatically determining, by the computer, transition points for the music file so that images will be displayed for at least the minimum image display time when the movie file is played, the transition points occurring during the louder portions of the music, and
automatically associating, by the computer, images from the image file with the transition points to create the movie file.

10. The method of claim 9, further comprising automatically checking, by the computer, whether the display time of any image exceeds a maximum image display time when the movie file is played, and when an identified image exceeds the maximum image display time, adding an appropriate number of images so that all images are displayed for less than the maximum image display time.

11. The method of claim 10, wherein the identified image and the added images occur during a quiet portion of the music, and further comprising automatically adjusting, by the computer, the transition points so that the identified image and the added images will be displayed for approximately equal times when the movie file is played.

12. The method of claim 9, wherein the minimum image display time is automatically determined based on the pace of the music

13. The method of claim 9, wherein the transition points correspond to the strongest beats in the music.
